(19) United States
(12) Patent Application Publication
(10) Pub. No.: US 2019/0294730 A1
(43) Pub. Date: Sep. 26, 2019

(54) DEVICE-BASED SEARCH IN DATA STORAGE DEVICE

(71) Applicant: Western Digital Technologies, Inc., Irvine, CA (US)

(72) Inventors: DEAN M. JENKINS, LA CANADA-FLINTRIDGE, CA (US); DALE C. MAIN, LA CANADA-FLINTRIDGE, CA (US)

(21) Appl. No.: 14/547,500

(22) Filed: Nov. 19, 2014

(51) Int. Cl. G06F 17/30

(52) U.S. Cl. CPC G06F 17/30864

(57) ABSTRACT

Systems and methods are disclosed for distributed searching in a data storage system. A data storage device may include a volatile memory module, a non-volatile memory module and control circuitry configured to perform a search on data stored in the non-volatile memory module according to search criteria. The control circuitry is further configured to store search results associated with the search in one or more of the volatile memory module and the non-volatile memory module and provide at least a portion of the search results to a host system.

### BACKGROUND

### Field

This disclosure relates to data storage systems. More particularly, the disclosure relates to systems and methods for performing distributed searching of data.

### Description of Related Art

Searching of data stored in one or more data storage devices can involve uploading the data to be searched to a host device or system and performing searching on the uploaded data at the host. Host searching can present various drawbacks associated with the need to upload the data to be searched prior to searching.

### BRIEF DESCRIPTION OF THE DRAWINGS

Various embodiments are depicted in the accompanying drawings for illustrative purposes, and should in no way be interpreted as limiting the scope of this disclosure. In addition, various features of different disclosed embodiments can be combined to form additional embodiments, which are part of this disclosure.

FIG. 1 is a block diagram representing a data storage system according to an embodiment.

FIGS. 2A and 2B are block diagrams representing data storage systems according to one or more embodiments.

FIG. 3 is a block diagram representing a data storage device according to an embodiment.

FIG. 4 is a flow diagram illustrating a process for performing distributed searching according to an embodiment.

FIG. 5 is a flow diagram illustrating a process for performing distributed searching according to an embodiment.

FIGS. 6A and 6B are flow diagrams illustrating processes for performing distributed searching according to one or more embodiments.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions and changes in the form of the methods and systems described herein may be made without departing from the scope of protection.

The headings provided herein are for convenience only and do not necessarily affect the scope or meaning of the claims. Disclosed herein are example configurations and embodiments relating to controller board layouts in data storage systems.

### Overview

Various storage server systems allow for host data to be transferred between a host and one or more data storage devices. For example, raw data may be written to an object storage device (OSD) of the system, wherein the data is uploaded by the host in order to be searched and/or indexed. Such uploading may consume a significant amount of system data bandwidth associated with transfer and/or compute operations.

Certain embodiments disclosed herein provide for distributed searching of data stored in one or more data storage devices (e.g., OSDs). For example, the search may be performed locally on an OSD, under host control, without the need for transferring the data from the storage device to the host for external searching. Distributed searching may provide a reduced burden on the host. For example, with distributed searching, the host may achieve data analysis with little more than command and/or result collection performed by the host, itself.

Distributed searching may be performed using certain hardware mechanism(s) configured to perform data comparisons. The hardware may be configured to store hit object keys and enable data comparisons at various levels of storage device operations. Distributed search capability in an OSD may substantially improve performance and/or reduce client compute demands. Adding distributed search capability to OSDs may provide increased efficiency of data searching. In certain embodiments, the priority of a search can be aligned with other internal tasks of a solid-state or hard disk storage drive/device to further improve efficiency. With respect to shingled media recording, distributed searching may be performable in the context of specific search ranges based on when data (e.g., objects) were written to the media. While certain embodiments are disclosed herein in the context of object-based storage, it should be understood that the principles discussed may be applicable in other types of storage systems, such as file-based storage, block-based storage, or the like.

### Data Storage System

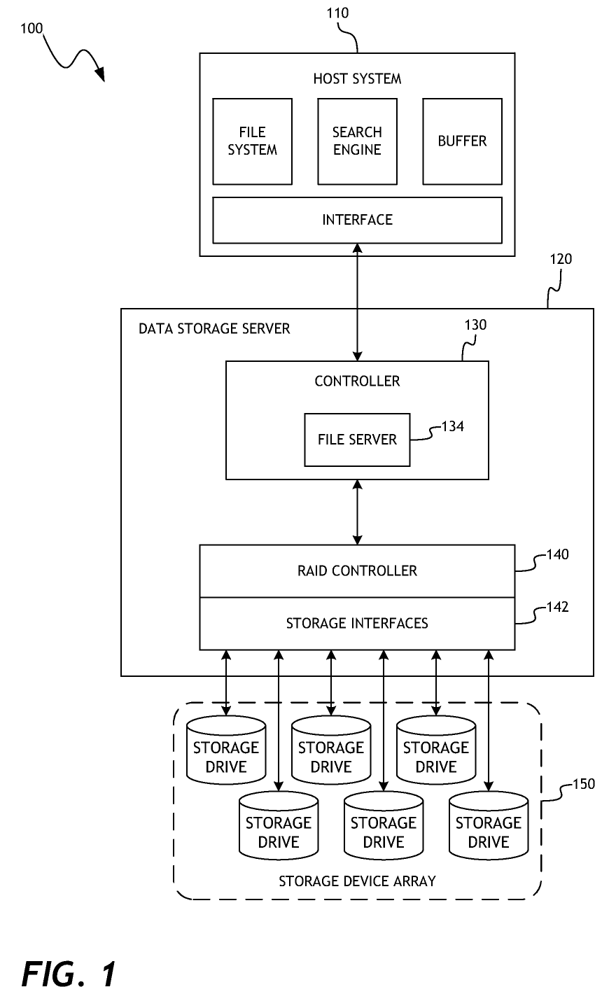

FIG. 1 illustrates a system 100 comprising a host system 110 in communication with a data storage server 120. The data storage server 120 may comprise a collection of hardware and/or software components or modules configured to provide access to data storage media associated with the server. For example, the data storage server 120 may be configured to provide access to one or more data storage devices 150 to the host system 110. In certain embodiments, the host system 110 communicates with the data storage server 120 over a computer network. For example, the data storage server 120 may be accessible over the Internet or other computer network. The host system may communicate over the network using an Ethernet interface, or other network interface.

The system 100 includes one or more data storage devices, which may be part of a collective storage device array 150, as shown. The data storage devices of the data storage device array 150 may comprise any type of data storage, such as solid-state storage, optical storage, magnetic disk storage, or other type of storage media. Furthermore, the storage device array 150 may comprise any number of data storage devices which may be individually and/or collectively accessible by the data storage server 120. As used herein, “non-volatile solid-state memory,” “non-volatile memory,” “NVM,” or variations thereof may refer to solid-state memory such as NAND flash. However, the systems and methods of this disclosure may also be useful in more conventional hard drives and hybrid drives including both solid-state and hard disk components. Solid-state memory may comprise a wide variety of technologies, such as flash integrated circuits, Phase Change Memory (PC-RAM or PRAM), Programmable Metallization Cell RAM (PMC-RAM or PMCm), Ovonic Unified Memory (OUM), Resistance RAM (RRAM), NAND memory, NOR memory, EEPROM, Ferroelectric Memory (FeRAM), MRAM, or other discrete NVM (non-volatile solid-state memory) chips.

In certain embodiments, the host system 110 is configured to manage a file system, wherein data storage access commands issued by the host system 110 to the data storage server 120 identify one or more files to be written or accessed. The data storage server 120, in turn, may be configured to receive such storage access commands including file information, and locate data stored in the one or more data storage devices 150 using the file identification information. In certain embodiments, the data storage server 120 includes a RAID controller 140. The RAID controller 140 may be configured to divide data files into sub-segments of data for storing across a plurality of data storage devices of the data storage device array 150, which may be connected to the data storage server 120 over a storage interface. For example, one or more devices of the storage device array 150 may be connected to the data storage server 120 over a SATA interface, or other type of interface. Furthermore, when retrieving data from the storage device array 150, the RAID controller 140 may be configured to reassemble data from multiple storage devices into files for providing such files to the host system 110 using the file server 134.

As described herein, it may be desirable for the host system 110 to search data stored in the storage device array 150 in order to identify terms and/or files stored in the storage device array 150. To such end, in certain embodiments, it may be necessary for the host system to provide one or more commands to the data storage server requesting that data to be searched be uploaded to the host system 110 from the storage device array 150, wherein the host system 110 is configured to receive and store or buffer the data to be searched, and further to search the data using a search engine of the host system, or other search engine external to the data storage server 120. However, such searching processes may demand undesirable amounts of bandwidth over the network or other connection between the host system 110 and the data storage server 120 based on the requirement that the data to be searched be transferred between the data storage server 120 and the host system 110. Furthermore, host system performance may be negatively affected by the requirement that the host system 110 perform such searching itself.

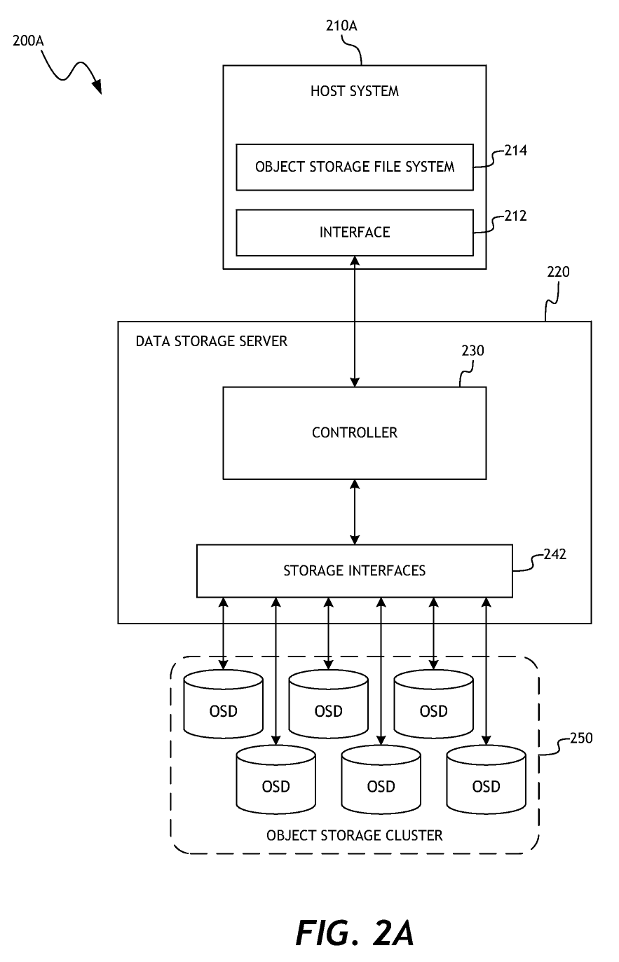

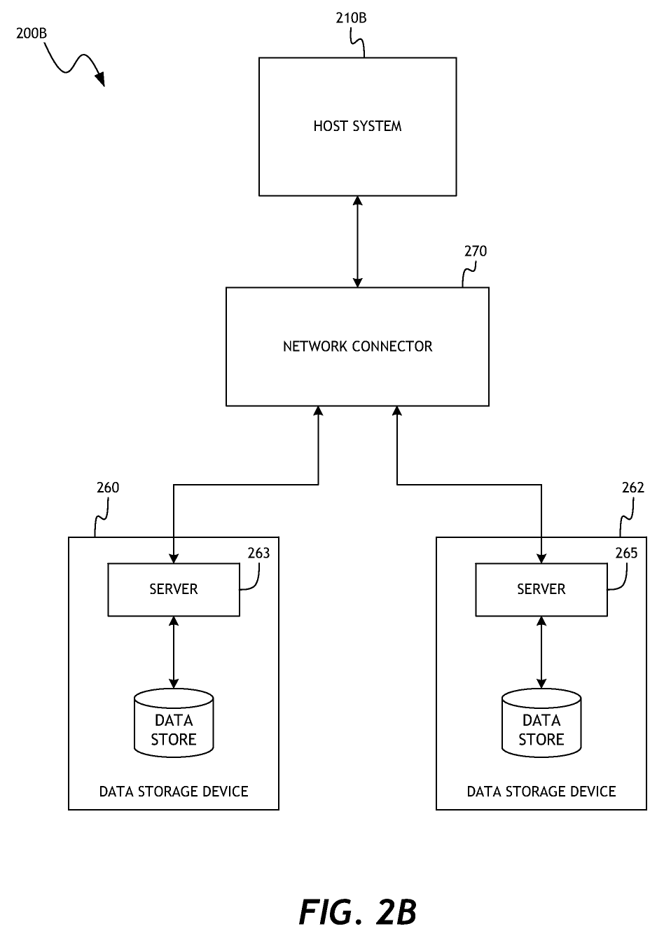

FIG. 2A illustrates a system 200 configured to implement object-level data storage. In the system 200 of FIG. 2A, the host system 210A maintains an object storage file system 214, which may provide functionality for managing data as objects by the host system 110. That is, one or more object storage devices (OSD) in a data center application may be utilized to store un-indexed “raw” data. That is, instead of storing files, the host system 210A may break files up into objects for storing, and put the objects back together to recreate the files. Although certain embodiments are described herein in the context of “objects,” it should be understood that “objects,” as used herein, may refer to any sub-segment of data, such as pieces, shards, blocks, blobs, and the like, and may refer to sub-segments having any desirable size. In certain embodiments, the server 220 may have no knowledge of the relationship between the objects stored in the OSD(s) 250. In order to understand and analyze the objects, certain embodiments provide for the objects to be read back by the main client and subsequently searched for key words and strings. However, alternatively, the data storage server or OSD(s) may be configured to perform distributed searching of data, wherein the data need not be uploaded to the host 210A for analysis.

The object storage file system 214 may operate according to any desirable storage platform that provides object, block, and/or file storage. For example, the host system 210 may implement Ceph, Hadoop, Swift, or other type of object storage management software system. In communications between the host system 210A and the data storage server 220, the host system 210A may provide data storage access commands identifying data by object key and may provide data to the data storage server 220 as objects, rather than files. In addition, the data storage server, when servicing a data storage access command, may provide data to the host system 210A as objects, wherein the host system 210A is configured to reassemble the received objects into files for use by the host system.

Because the data storage server 220 operates on data as objects, the controller 230 of the data storage server 220 may be configured to distribute said objects among a plurality of object storage devices, which are part of an object storage cluster 250, as shown. In certain embodiments, the controller 230 includes an object server module (not shown). The data storage server 220 may communicate with one or more of the object storage devices of the object storage cluster or pool 250 over one or more storage interfaces 242.

FIG. 2B illustrates a system 200B providing an alternative topology for communications between a host system 210B and one or more data storage devices 260, 262. In the system 200B, the host system 210B may be configured to communicate with a plurality of data storage devices 260, 262, over a network. Such communication may be facilitated by a network connector 270, such as a network switch or the like. For example, the host system 210B may be connected to the network connector 270 over an Ethernet connection, or other network connection. Furthermore, the data storage devices 260, 262 may be connected to the network connector 270 over an Ethernet connection, or other network connection.

In certain embodiments, the host system 210B provides data storage access commands to the data storage devices 260, 262 using object-level access, as described above. Each of the data storage devices 260, 262 may comprise a storage access server (263, 265) as well as a non-volatile data storage module, or data store. Therefore, according to the system 200B, the host system 210B may communicate directly, or substantially directly, with the individual data storage devices 260. That is, no intermediate data storage server may be necessary to facilitate communications between the host system 210B and the data storage devices 260, 262. The on-device servers 263, 265, may comprise micro-servers providing access to on-board data storage.

### Distributed Searching

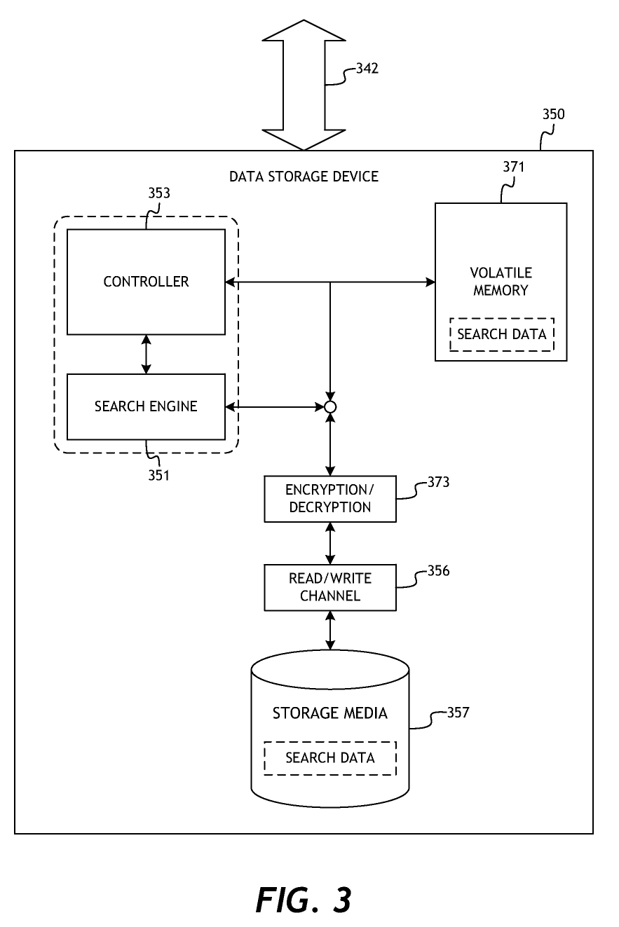

FIG. 3 illustrates an embodiment of an data storage device 350, which may be configured to provide distributed searching of non-volatile storage media 357, which may be a component of the data storage device 350, or may be otherwise communicatively coupled to the data storage device 350. The data storage device 350 may be configured to be connected to a host system (not shown) over a network interface 342, such as an Ethernet connection or other network connection.

The data storage device 350 includes a controller 353 and a search engine module 351. The data storage device 350 further includes a volatile memory (e.g., DRAM) 371 as well as the storage media 357, read/write channel 356 and encryption/decryption module 373. In certain embodiment, the data storage device 350 may be configured to receive data over the interface 342 from a host system and store such data in the storage media 357. In certain embodiments, the data storage device 350 may buffer data being transferred to and/or from the storage media 357 in the volatile memory 371. Furthermore, data transferring to and from the storage media 357 may have encryption/decryption operations performed thereon in order to provide data security. The data storage device 350 comprises a read/write channel 356, which may include hardware logic for communicating with the storage media 357.

In certain embodiments, the data storage device 350 is configured to perform searches on data stored in the storage media 357, such as at the request of a host or other client connected to the storage device 350 over the interface 342. Said searches may be performed at least in part using the search engine 351, which may comprise hardware logic and/or firmware executed by the controller 353. For example, the data storage device 350 may be configured to transfer data to the storage media 357 over one or more data transmission paths or lines. In certain embodiments, the search engine 351 is configured to access, or “sniff,” said communication paths or lines during transfer to or from the storage media 357, wherein the data being transferred is tapped by the search engine 351 and submitted to one or more hardware logic components, such as logical compares and/or the like. Alternatively, or additionally, the data may be buffered and inspected under the execution of device software/firmware. In certain embodiments, searching logic is implemented at least in part using one or more field programmable gate arrays (FPGAs), which may be reprogrammable in the event that search criteria is changed. The search engine 351 may comprise a combination of hardware (fixed and/or reprogrammable) and software/firmware.

Search results may be maintained in a hit table or other type of data structure, wherein instances and/or occurrences of data that is the subject of the search may be identified in some manner. For example, data may be identified by object key (e.g., hash key), LBA, or other identifier, depending on the type of storage system. When a hit is found, the location, or other identifier, of the found data may be stored in the hit table, and results based on the hit table may be provided to the host according to a search results reporting scheme. In an embodiment, the matching data associated with the search may be returned to the host.

In an embodiment wherein the search engine 351 comprises a hardware comparison engine, the engine may include multiple client-requested data compares. The compares may be independent or linked for sequential ordering of the compares. When reading data from the storage media 357, the compare feature may attach in such a way as to “sniff” the data path after decryption at module 373 but prior to buffering in the volatile memory 317 (e.g., DRAM). In certain embodiments, transferring of data to the volatile memory 371 after retrieval from the storage media 357 may be optional. When a comparison match is found, the matching data's physical location may be stored in the volatile memory 371 and/or storage media 357 for, e.g., later reverse lookup to the object key. Separate match queues may be created in the volatile memory 371 for each separate search so as to prevent intermingling of search data. If the comparator modules are tied in a sequential fashion, only one match queue may be used and the start location of the entire string match may be stored in the search data according to an embodiment.

In certain embodiments, the positioning of the hardware engine alongside the data path may not substantially affect the normal operation of the data path. Furthermore, as described in greater detail below, enabling the searching functionality during various background operational states can provide advantages that may be realized internally to the storage device.

The data storage device 350 may be configured to perform data searches according to certain search criteria, which may be provided to the data storage device 350 by a host, or may be pre-configured in the object storage device. For example, the data storage device 350 may be configured to search data for various keywords, terms, files, data patterns, or other data types or identifiers. In certain embodiments, in connection with such searching, the data storage device 350 may be configured to store search result data in one or more of the volatile memory 371 and the storage media 357. For example, this data storage device 350 may maintain one or more hit tables, or other types of data structures comprising data identifying the location and/or number of instances or copies of a particular keyword or term that is the subject of the search.

The data storage device 350 may be configured to provide the search results to the host or client over the interface 342. For example, the data storage device 350 may provide search results data to the host periodically, or at specific intervals or points in time. The timing of provision of search results to the host may be in accordance with a priority of the search or search results. For example, the host may specify to the object storage device when and/or how search results are to be provided. As an example, with respect to high-priority searches, the data storage device 350 may be configured to provide search results substantially immediately after performance of the associated search. Alternatively, the data storage device 350 may simply maintain the search result data and provide such data to the host at predetermined periodic intervals, for example, in connection with lower-priority searches. In certain embodiments, search results/status is made available after the search is complete from volatile memory (e.g., DRAM) to the host.

In a system comprising a cluster, or pool, of object storage devices configures as illustrated in FIG. 3, distributed searching may be performed at least partially in parallel on multiple devices. For example, a search may be divided up among the storage devices, thereby reducing the amount of searching any individual device must perform. Alternatively, different storage devices may perform the same search in parallel, potentially providing improvement in search integrity. In an embodiment, replicate copies of data are searched by different storage devices in parallel, wherein when one of the storage devices locates a search hit (or hits), an abort signal or other indication may be provided to the remaining storage devices directing such storage devices to cease or reduce searching efforts in order to conserve system resources.

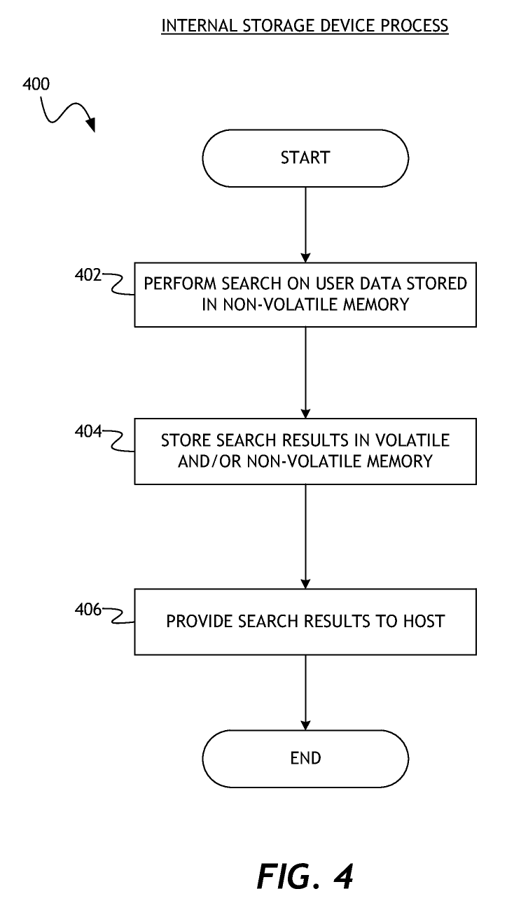

FIG. 4 is a flow diagram illustrating a process 400 for performing data searching in a data storage system. The process 400 may be performed at least in part by a data storage device, which may be connected to a host or client system over an interface. In certain embodiments, the process 400 is performed at least partially under the control of a controller of the data storage device. The process 400 involves performing a search on user data stored in non-volatile memory of the data storage device at block 402.

The search may be performed in response to an object search command received from a host system. The command may include search priority level and/or range data. The priority data may indicate when the search is to be performed by the storage device. For example, the priority data may indicate that the search is to be performed substantially immediately upon receipt of the command. Such high priority searching may be performed internal to the data storage device without transferring the data to be searched to the host. Alternatively, the priority data may indicate that the search is to be performed during storage device operation idle time. As another example, the priority data may indicate that the search is of relatively low priority and may be performed during other background tasks, such as storage device maintenance, diagnostics, refreshing, or other background tasks/operations. In certain embodiments, the search commands described herein may be in accordance with command and status protocol not previously provided in the art in order to provide control of the search functionality by the host system. The definition of this protocol may be included in documentation provided together with the data storage device itself. In certain embodiments, the search command may be a vendor-specific command.

Range data included in a search command may specify a range or group of physical memory locations where the search should be performed. For example, the range data may indicate that the entire storage device, or an entire object stored in the storage device, is to be searched. Range data may also specify logical memory locations. For example, in a data storage device where address indirection is used (e.g., shingled magnetic recording (SMR) embodiments), the range (or zone) data may indicate an old data range (e.g., written prior to specific object), or a new data range (e.g., written after a specific object). Since data is generally written to such a data storage device (e.g., SMR drive or solid-state drive) in a sequential fashion based on the order of incoming commands, knowledge of such sequence may assist in the range specification.

With further reference to FIG. 4, a controller and/or other software and/or hardware modules of the data storage device may be configured to perform searching on data stored in the data storage device independently of the host or client, thereby providing distributed searching functionality, as described herein. The search performed at block 402 may be done in accordance with certain search criteria, which may identify certain terms, files or other data, as well as address ranges or the like associated with the search performed. The search may be performed according to certain priority parameters, which may be provided by the host or otherwise determined by the data storage device. In certain embodiments, the search may be performed during certain background processes or operations of the data storage device.

The distributed searching functionality may be implemented using existing storage device/drive firmware in order to provide bandwidth and/or computational benefits. In certain embodiments, searching is performed at least in part by hardware components implemented in system-on-a-chip (SoC) logic, wherein the hardware allows for searching during storage device background operations.

At block 404, the process 400 involves storing search results associated with the search performed at block 402. Such search results may be stored, for example, in a volatile memory buffer of the data storage device and/or in the non-volatile memory of the data storage device. Such search results may comprise, for example, a hit table or the like, which may identify physical locations of instances of a particular search term or phrase with in the non-volatile memory of the storage device.

At block 406, the process 400 involves providing the search results to the host or client over an interface. For example, the search results may be provided at periodic or sporadic intervals, and may be provided in accordance with search result priority parameters, as indicated by the host or otherwise determined by the data storage device. In certain embodiments, search results may be provided to the host on-demand. For example, the storage device may service the request as it is received and provide the search results to the host as soon as they become available. In certain embodiments, the process 400 may be performed at least partially under the control of a controller of the data storage device.

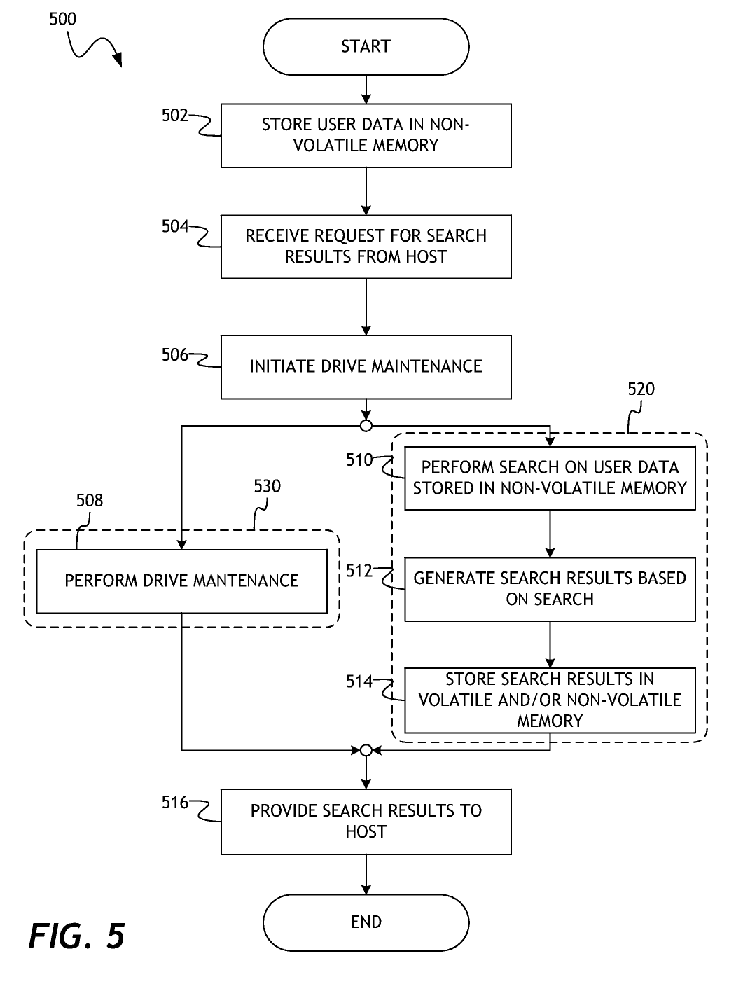

FIG. 5 illustrates a process for performing distributed data searching according to one or more embodiments disclosed herein. The process 500 involves storing user data in a non-volatile memory of a data storage device at block 502. For various purposes, it may be desirable for such user data stored in the non-volatile memory of the data storage device to be searched in order to identify occurrences or instances of certain terms, phrases, files or other data. At block 504, the process 500 involves receiving a request for search results from a host or client communicatively coupled to the data storage device, such as over a computer network. For example, the host may be coupled to the data storage device over the Internet. Alternatively, the host system and data storage device may be components of a single computing device or system, such as a laptop, desktop, tablet, smartphone, or other type of computing device.

The process 500 may involve determining a priority associated with the request for search results received from the host at block 504. Such priority information may indicate a priority associated with performance of the search and/or provision of search results associated with the search. In certain embodiments, the data storage device may be configured to implement searching of data stored thereon during background, maintenance, or other types of operations executed in due course by the data storage device. For example, it may be determined whether the requested search is of a low priority, or substantially low priority, wherein said search may be performed as convenient to the data storage device. That is, with respect to low priority search, it may be unnecessary to perform said search substantially immediately upon receipt of the request; the search may be performed substantially simultaneously, or in connection, with one or more other operations executed by the data storage device.

For a low priority search, the data storage device may wait until initiation of storage device maintenance or other background operations as directed by a controller of the data storage device. At block 506, storage device maintenance or other background operations may be initiated. The process 500 proceeds to implement parallel operations of two branches of the flow diagram, each branch representing a sub-process of the process 500. For example, the process 500 may involve substantially simultaneously performing a storage device maintenance or background operation or operations identified by sub-process 530 with the performance of a data search sub-process 520.

In certain embodiments, the storage device background/maintenance operations may comprise one or more of the following: garbage collection operations, wear leveling operations, storage device/data refresh operations, cache flushing/destaging operations, diagnostics and/or testing operations, data transfer operations, wherein data is transferred to and/or from non-volatile storage of the data storage device. Since many such types of operations involve reading of previously written data, the search can be performed, for example, while such data is read as part of the background/maintenance operation. Although certain types of background or maintenance operations are disclosed herein, it should be understood that searching processes as described herein may be performed in connection with any other types of operations that may be at least partially simultaneously performed with distributed searching.

The data searching sub-process 520 may involve searching of data stored in non-volatile memory of the data storage device. Such non-volatile memory may comprise hard disk storage and/or solid-state storage, or any other type of non-volatile storage or combination thereof. The sub-process 520 may involve performing a search on data stored in the non-volatile memory at block 510 and generating search results associated with said search a block 512. The search results may comprise, for example a hit table or other data structure indicating physical location, number of occurrences, and/or other information associated with instances of a particular search term, phrase, file, or other data that is a subject of the search. The search results may be stored permanently or temporarily in one or more storage modules of the data storage device. For example, the search results may be buffered in volatile memory of the data storage device and/or may be stored in the non-volatile memory.

At block 516, the process 500 involves providing the search results, or portion thereof, to the host. In certain embodiments, said provision of search results may be performed in accordance with priority parameters associated with the search. For example in an embodiment, search parameters may indicate whether search results are to be provided substantially immediately upon completion of the search and/or generation of search results, or at some other later time. In certain embodiments, the search results are provided in response to direct request for the search results, wherein said request may be received after performance of the search.

While FIG. 5 illustrates simultaneous searching during background task operations, certain embodiments provide for commanded search applications, wherein the storage device may receive a command for searching without waiting for background task performance. In such a situation, the connection from the data path to volatile memory may be optional, which may provide power savings.

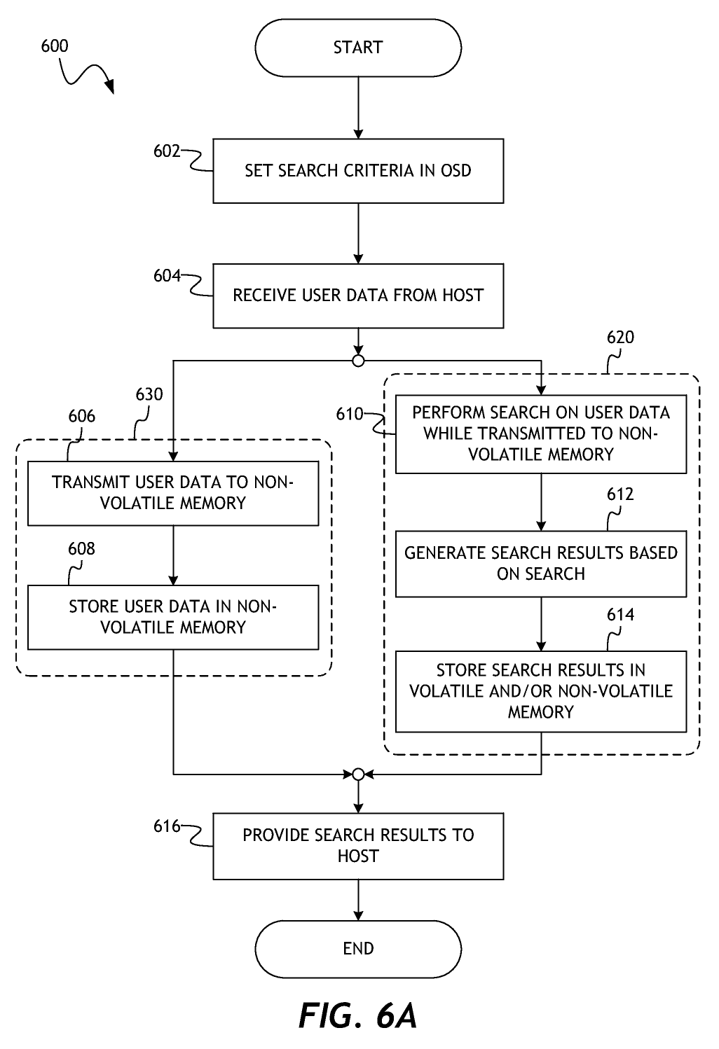

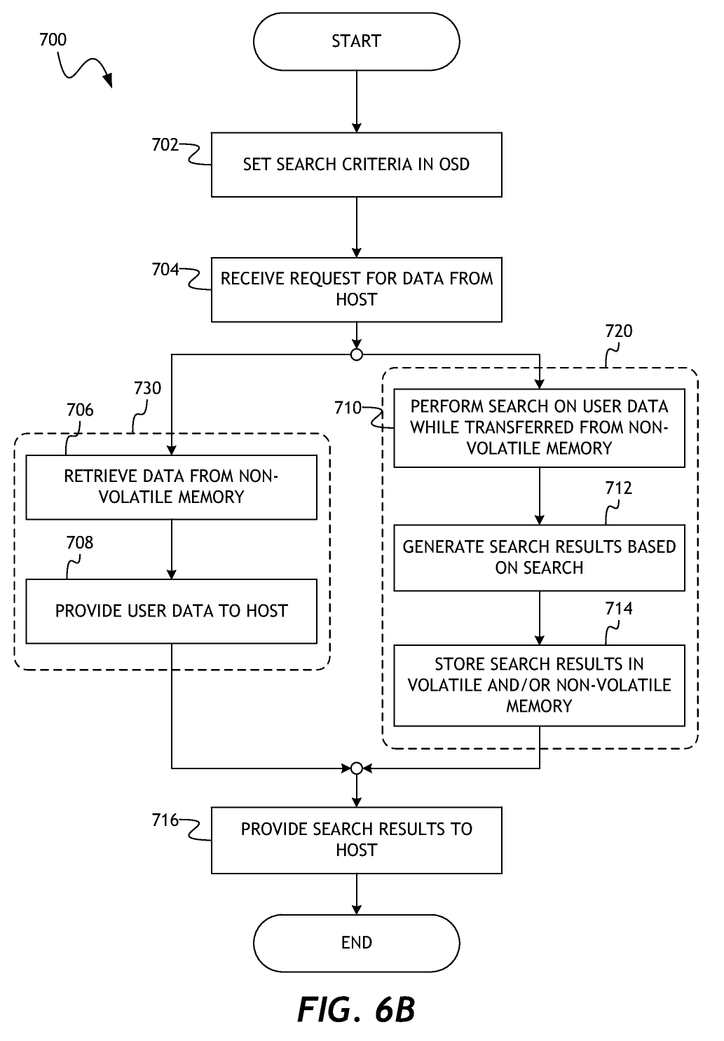

FIG. 6A illustrates a process 600 for performing distributed data searching according to one or more embodiments disclosed herein. At block 602 the process 600 involves setting certain search criteria in an object storage device or other data storage device. For example, the search criteria may be embodied in device firmware or software, or in hardware logic. Search criteria may indicate parameters for a search of data stored in the data storage device, wherein such parameters may include range of addresses or physical memory locations to be searched, terms, keywords, files, objects, or other identification of data to be identified from among the data stored in the data storage device as part of the search.

At block 604, the data storage device receives user data from a host, wherein the user data is to be stored in non-volatile memory of, or associated with, the data storage device. The process 600 further involves storing the user data in the non-volatile memory. However, as described herein, as the user data is transferred to the non-volatile memory of the data storage device as part of the sub-process 630, the process 600 may involve taking advantage of such data movement for the purposes of searching the data being transferred within the data storage device. As shown in parallel sub-process 620, the process 600 may involve performing searching on the user data while it is transmitted to non-volatile memory at block 610. For example, in an embodiment in which data is transferred to the non-volatile memory along one or more hardware data paths, performing the search at block 610 may involve tapping, or accessing, the data paths in order to inspect the data as it is transferred. Furthermore, the searching may be performed using hardware logic gates and/or components configured to execute the desired search according to the search criteria. Alternatively or additionally, performing the search may involve executing firmware/software instructions that embody the search criteria using a controller or controller logic of the data storage device. With respect to software-based searching, the process 600 may involve buffering the data as it is transferred to the non-volatile memory array in a memory module that may be utilized for searching purposes.

At block 612, the process 600 involves generating search results based on the performed search. For example, such search results may include a hit table or other type of data or data structure that comprises information identifying search hits by physical location and/or other identifying parameters. The search results may be stored in one or more memory modules or components of the data storage device at block 614. For example, the search results may be maintained in the non-volatile memory or other non-volatile memory of the data storage device or associated therewith. Additionally or alternatively, the search results may be maintained in temporary storage, such as in the volatile system memory or other volatile memory or cash of the data storage device.

At block 616, the process 600 involves providing the search results to the host. Search results may be provided to the host periodically and/or sporadically, according to any desirable scheme. For example, in certain embodiments the search criteria and/or request from the host comprises search priority information which may indicate a preference for when the search results are to be provided to the host. For example, the priority information may indicate that search results are to be provided substantially immediately after performance, or during performance, of the search. Alternatively, search criteria and/or priority information may indicate that the search results may be provided after predetermined amount of time, or at predetermined intervals, or at the convenience or preference of the data storage device. In certain embodiments, search hits are communicated to the host as they are discovered, regardless of whether the search has been completed.

FIG. 6B provides an alternative process 700 in which data searching is performed in connection with retrieval of user data from the non-volatile memory of the data storage device and transfer to the host. In a similar fashion to the process 600 of FIG. 6A, the searching sub-process 720 may take advantage of a transfer of user data between non-volatile memory of the data storage device, or associated there with, and the host.

At block 702, search criteria is determined or set in the data storage device, as described above. At block 704, a request is received from a host for data stored in non-volatile memory of, or associated with, the data storage device. The sub-process 730 of the process 700 involves retrieval of the requested data and provision thereof to the host at block 706 and 708, respectively. The sub-process 720 may be similar in certain respects to the sub-process 620 of FIG. 6A. At block 710, searching is performed at least partially in parallel with retrieval and/or provision of user data to and/or from the non-volatile memory array and the host. At block 712, search results are generated based on the search, and such search results are stored in volatile and/or non-volatile memory at block 714. At block 716, the search results are provided to the host, according to any desirable scheme, as described above.

Although FIGS. 6A and 6B specify processes wherein searching is performed in parallel with data transfer to non-volatile memory and retrieval therefrom, respectively, any data movement within the data storage device may serve as an opportunity to perform searching as described herein. For example, data may be moved within the data storage device for various device maintenance or other purposes, such as garbage collection, data refreshing, wear leveling, or other operations involving manipulation and/or movement of data stored in non-volatile memory. Furthermore, discussion of garbage collection operations herein may be related to garbage collection for solid-state memory, shingled magnetic recording storage, or any other type of data storage media.

Certain embodiments of distributed data searching as disclosed herein may provide various benefits. For example, the ability to perform searches on data in background operations may provide power savings, as performance of such background tasks may be necessary or desirable in any event. Generally, only the storage device, not the host, can combine these operations. Therefore, distributed searching as disclosed herein can allow for combining such operations to achieve power savings in a manner that is unachievable in certain other systems. For example, distributed searching may result in an increased number of parameters per watt achieved by the storage system.

Where searching is enabled during background operations, substantially no performance loss may be visible from the host perspective. Large searches may be performed in an on-going manner in the background. Furthermore, distributed searching with priority levels and status done in the background may involve utilization of data movement that is already performed in the storage device at substantially no power cost.

Distributed searching may also provide reduction in search time by limiting the scope of a search in a shingled storage device to a range of data based on when it was written; an SMR-based or SSD-based object storage device may generally have knowledge of the order of incoming data since it is stored sequentially. Distributed searching may further provide reduction of data traffic between the main client and the data storage server/device, and may off-load the computation-intensive portion of the search from the host.

### Additional Embodiments

Those skilled in the art will appreciate that in some embodiments, other types of distributed searching systems can be implemented while remaining within the scope of the present disclosure. In addition, the actual steps taken in the processes discussed herein may differ from those described or shown in the figures. Depending on the embodiment, certain of the steps described above may be removed, and/or others may be added.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. The accompanying claims and their equivalents are intended to cover such forms or modifications as would fall within the scope and spirit of the protection. For example, the various components illustrated in the figures may be implemented as software and/or firmware on a processor, application-specific integrated circuit (ASIC), field-programmable gate array (FPGA), or dedicated hardware. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

All of the processes described above may be embodied in, and fully automated via, software code modules executed by one or more general purpose or special purpose computers or processors. The code modules may be stored on any type of computer-readable medium or other computer storage device or collection of storage devices. Some or all of the methods may alternatively be embodied in specialized computer hardware.

1. A data storage device comprising:
host interface circuitry;
a volatile memory device;
a non-volatile memory device;
a controller configured to:
receive user data from a host system using the host interface circuitry; and
transfer the user data to the non-volatile memory device over a data path comprising one or more data transmission lines electrically coupling the controller to the non-volatile memory device; and
search engine circuitry separate from the controller and the non-volatile memory device and coupled to the data path, the search engine circuitry comprising a plurality of hardware comparators in a sequential arrangement, each of the plurality of hardware comparators being associated with a separate search term of a plurality of search terms, wherein the search engine circuitry is configured to:
compare the user data transferred from the controller to the non-volatile memory device over the data path to the plurality of search terms to generate comparison matches; and
store the comparison matches in one or more of the volatile memory device and the non-volatile memory device, the comparison matches identifying locations of instances of the one or more search terms in the non-volatile memory device.

2. The data storage device of claim 1, wherein the search engine circuitry is configured to compare the user data to the plurality of search terms as it is transferred between the controller and the non-volatile memory device over the data path.

3. (canceled)

4. The data storage device of claim 1, wherein:
the search engine circuitry is coupled to the data path at a coupling node; and
the data storage device further comprises one or more of encryption/decryption circuitry and read/write channel circuitry disposed in the data path between the coupling node and the non-volatile memory device.

5. The data storage device of claim 1, wherein the search engine circuitry is programmable by the host system.

6. The data storage device of claim 18, wherein:
the volatile memory device is configured to communicate with the non-volatile memory device at least partially over the data path: and
the controller is further configured to perform the comparison at least in part by accessing the data path.

7. (canceled)

8. The data storage device of claim 18, wherein the comparison matches are stored in a hit table.

9. The data storage device of claim 18, wherein the controller is further configured to:
Initiate a maintenance operation associated with the non-volatile memory device; and
perform the comparison in response to the initiation of the maintenance operation.

10. The data storage device of claim 9, wherein the maintenance operations is one of a garbage collection operation and a diagnostics testing operation.

11. (canceled)

12. (canceled)

13. The data storage device of claim 18, wherein:
the controller is further configured to initiate cache de-staging operations associated with the non-volatile memory device; and
said comparing is performed in response to the initiation of the cache de-staging operations.

14. The data storage device of claim 18, wherein:
the controller is further configured to initiate data refresh operations associated with the non-volatile memory device; and
said comparing is performed in response to the initiation of the data refresh operations.

15. The data storage device of claim 18, wherein:
the controller is further configured to receive priority data from the host system; and
said comparing is performed according to the priority data.

16. The data storage device of claim 15, wherein the priority data indicates that the comparison is to be performed at one of the following times: substantially immediately, during storage device operation idle time, or during performance of one or more background tasks.

17. (canceled)

18. A data storage device comprising:
host interface circuitry;
a volatile memory device;
a non-volatile memory device; and
a controller configured to:
receive user data from a host system using the host interface circuitry; and
transfer the user data to the non-volatile memory device over a data path comprising one or more data transmission lines electrically coupling the controller to the non-volatile memory device; and
search engine circuitry separate from the controller and the non-volatile memory device and coupled to the data path, the search engine circuitry comprising hardware comparison circuitry and configured to:
compare the user data as it is transferred from the controller to the non-volatile memory device over the data path to search terms to generate comparison matches; and
store the comparison matches in one or more of the volatile memory device and the non-volatile memory device, the comparison matches identifying locations of instances of the search terms in the non-volatile memory device.

19. The data storage device of claim 18, wherein the controller is preprogrammed with the search terms.

20. The data storage device of claim 18, wherein the controller is further configured to provide at least part of the comparison matches in response to a request from the host system.

21. A method of searching data in a data storage device, the method comprising:
by control circuitry of a data storage device:
receiving user data from a host computing device over a host interface;
buffering the user data in a volatile memory device of the data storage device over a data path comprising one or more data transmission lines electrically coupling the controller to the volatile memory device;
decrypting the user data using decryption circuitry disposed in the data path between a controller of the control circuitry and the volatile memory device;
performing a comparison of the user data to search terms using hardware comparison circuitry as the user data is transferred over the data path between the decryption circuitry and the volatile memory device to generate comparison matches;
storing the comparison matches in one or more of the volatile memory device and a non-volatile memory device of the data storage device, the comparison matches identifying locations associated with instances of the search terms; and
providing at least a portion of the comparison matches to the host computing device.

22. The method of claim 21, further comprising receiving a search command including the search terms from the host computing device.

23. The method of claim 21, wherein:
the user data comprises data objects; and
the data storage device is an object storage device (OSD).

24. (canceled)

25. The method of claim 21, wherein said performing the comparison is performed during performance of one or more of the following types of operations internally in the data storage device: garbage collection operations, diagnostics testing operations, cache de-staging operations, and data refresh operations.

26. (canceled)

27. The method of claim 21, further comprising receiving priority data from the host computing device, wherein the comparison is performed according to the priority.
